(19) United States
(12) Patent Application Publication
(10) Pub. No.: US 2023/0164662 A1
(43) Pub. Date: May 25, 2023

(54) METHOD AND NETWORK DEVICE FOR CONFIGURING END TO END DATA PATH IN TRANSPORT NETWORK

(71) Applicant: Sterlite Technologies Limited, Gurugram (IN)

(72) Inventors: Puneet Agarwal, Gurugram (IN); Bhushan Desai, Gurugram (IN)

(73) Assignee: Sterlite Technologies Limited, Gurugram (IN)

(21) Appl. No.: 17/705,255

(22) Filed: Mar. 25, 2022

(30) Foreign Application Priority Data
Nov. 23, 2021 (IN) 202111053896

(51) Int. Cl. H04W 40/12; H04W 56/00; H04W 28/02

(52) U.S. Cl. CPC H04W 40/12; H04W 56/0015; H04W 56/0055; H04W 28/0268

(57) ABSTRACT

Accordingly, the present disclosure provides a method and a network device (200) for configuring an end-to-end data path in a transport network (1000). The method includes computing at least one feasible data path between network nodes (800a-800r). The network nodes (800a-800r) are a part of different clock chains and relative to different grandmaster clocks for at least one time and latency-sensitive service. The at least one feasible data path is associated with a time synchronization protocol. Further, the method includes computing an E2E synchronization matrix for each of the at least one feasible data path based on a time and synchronization QoS parameter. The time and synchronization QoS parameter include a time error, a phase delay, a jitter, and a frequency offset observed on each network node (800a-800r) in a centralized controller.

### TECHNICAL FIELD

The present disclosure relates to wireless networks, and more specifically relates to a method and a network device for configuring an end-to-end data path in a transport network.

### BACKGROUND

In the currently deployed wireless network, only node level details of synchronization (sync) quality of service (QoS) parameters such as accuracy, time error (TE), phase delay, jitter, frequency offset, for example, can be assured, concerning its reference grandmaster clock. In telecom edge/access/aggregate networks, participating network nodes may be deriving timing and synchronization information from different grandmaster (GM) clocks which may have different values of clock QoS parameters (i.e., clock class, clock quality, TE, holdover performance, phase delay, jitter, etc.). As a result, values of timing and sync QoS parameters on each node of a prospective data path of service may vary and cumulative Time error (total TE) on a particular data path may exceed the tolerable QoS values and timing budget that are required to run a time sensitive service running on that data path. Thus, when a user (e.g., network administrator or the like) of the wireless network deploys a time-sensitive service over such a network path, there is no way to assure that timing and synchronization requirements for that end to end (E2E) service configuration would be satisfied.

In view of the above statements, FIG. 1 illustrates a conventional node-based architecture (100) for timing and synchronization purpose. The conventional node-based architecture (100) includes one or more GPS systems (102a and 102b), one or more grandmaster clocks (104a and 104b), one or more metro networks (106a-106h), one or more baseband processing units (BBU) pools (108a-108d) and one or more remote radio heads (RRHs) (110a-110h) and one or more synchronization paths (112a and 112b). In a city A (operated in a time domain A), a GPS system (102a) is provided with a grandmaster clock (104a), where the grandmaster clock (104a) is provided with metro networks (106a-106d). A metro network (106d) is provided with BBU pools (108a and 108b). A BBU pool (108a) is provided with the RRHs (110a and 110b), wherein a BBU pool (108b) is provided with the RRHs (110c and 110d). Similarly, in a city B (operated in time domain B), a GPS system (102b) is provided with a grandmaster clock (104b), where the grandmaster clock (104b) is provided with metro networks (106e-106h). A metro network (106f) is provided with BBU pools (108c and 108d). A BBU pool (108c) is provided with the RRHs (110e and 110f), wherein a BBU pool (108d) is provided with the RRHs (110g and 110h). If the one-hop time error is occurred between the metro networks (106a and 106b) then, time error accumulates along the synchronized path (112a). This may lead to link failure in the node-based architecture (100).

In the conventional node-based architecture (100), currently, time and phase synchronization in the wireless network (e.g., telecommunication network or the like) is provided to each network node with the help of IEEE 1588 PTP protocol and by employing different ITU-T PTP profiles. The synchronization related information is carried via PTP packets over an Ethernet (or over a User Datagram Protocol (UDP)) to network nodes and based on the timestamp information provided in these PTP packets each node gets synchronised with its associated grandmaster (GM). The current PTP protocol architecture (100) follows a node-based approach. Thus, in the current deployed wireless network, the user of the wireless network can only assure node level details of synchronization QoS parameters such as accuracy, time error (TE), phase delay, jitter, frequency offset etc. with respect to its reference grandmaster clock.

Further, especially in a Brownfield network deployment scenario, clock quality and clock QoS parameters differ for different GM clocks and in a greenfield deployment scenario, over the period of time it might be required to upgrade only some part of the network with better quality GMs thus creating a situation where different GMs have different values of clock QoS parameters. Further, another factor that affects the quality of the recovered clock at a network node is the hop distance from its associated grandmaster clock. The clock quality deteriorates as one moves farther away from the grandmaster.

Conclusively, a node-based architecture of timing and synchronization is a bottleneck when it comes to deploying a critical time sensitive service with stringent E2E synchronization QoS values and E2E strict timing and synchronization budget requirements. The conventional timing and synchronization architecture do not allow to monitor and ensure that each node in the prospective data path of a particular service has achieved the necessary E2E synchronization QoS requirements.

Further, in special cases of latency-sensitive services like network slicing service, connected cars service, self-driving car service, tele-surgery service, traffic efficiency and safety service, and high-frequency trading service, the user of the wireless network have stringent requirements over the QoS parameters of timing and synchronization. Hence, the current node-based architecture of timing and synchronization is a bottleneck when it comes to deploying the critical time-sensitive service with stringent E2E synchronization QoS values and E2E strict timing and synchronization budget requirements. Some of the prior art references are given below:

U.S. Pat. No. 9,258,735B2 discloses a wireless end-user device comprising a wireless wide-area network (WWAN) modem. A network element securely provisions the device with a differential traffic control policy list that distinguishes how network traffic for at least one network type should be treated on a per-application basis. A user is also allowed, through an interface, to configure one or more aspects of how a differential traffic control policy is applied to applications. One or more device agents classify whether an application is interacting with a user in a user interface foreground of the device and whether data communication for Internet service activities is provided through the WWAN modem. Based on the network- and user-configured policy information and the classifications, a network stack agent determines whether to allow or disallow a given Internet access request. Some requests that may otherwise be disallowed are allowed when the WWAN modem is already active to serve another request.

U.S. Ser. No. 10/284,318B1 relates to a packet-based computer networks and, more particularly, to synchronizing network device clocks within computer networks. A network controller manages a network having many network devices. Network devices can receive the timing flow port role assignments from the network controller based on the controller's global view of the network topology. The controller can also calculate timing offsets to be applied to the network devices, based on timestamp information obtained by the network devices via exchanging time synchronization protocol messages, and the controller can update time clocks on all of the network devices within a single window of time, based on timing offset calculated in a single iteration of calculations.

U.S. Pat. No. 9,979,595B2 discloses packet-based computer networks in which a method includes a centralized controller, dynamically establishing a control channel between the centralized controller and an access node in a software-defined network having a plurality of network nodes managed by the centralized controller; receiving, by the centralized controller, a services indication message from a network node of the plurality of network nodes. The services indication message indicates one or more network services provided by the network node in a software-defined network having a plurality of network nodes managed by the centralized controller; establishing, by a centralized controller, a transport label switched path (LSP) between the access node and the network node to transport network packets between the access node and the network node. Further, the method includes receiving, by the centralized controller, an endpoint indication message from the access node via the control channel, wherein the endpoint indication message indicates that an endpoint that has joined the network at the access node. Further, responsive to determining that a pseudo wire is needed between the access node and the network node to provide to the endpoint a network service of the one or more network services, the method includes outputting, by the centralized controller, a pseudo wire request message via the control channel to install forwarding state on the access node for creating the pseudo wire between the access node and the network node; and outputting, by the centralized controller, a direct switch message via the control channel to configure the access node to map traffic received from the endpoint to the pseudo wire.

In non-patent literature entitled “QoS-aware data forwarding architecture for multimedia streaming services in hybrid peer-to-peer networks”, a QoS-Aware Data Forwarding Architecture (QDFA) is proposed to guarantee QoS of multimedia streaming services in hybrid peer-to-peer networks. The QDFA performs end-to-end synchronization processes to provide QoS of multimedia streaming services. In the synchronization processes, QDFA measures accurate time based on IEEE 1588, and sets the synchronized paths. when transmits the packet to the synchronized paths, the QDFA based on the synchronized time bypasses the packet to the next-hop without processing delay. The QDFA guarantees multimedia streaming service quality in hybrid peer-to-peer networks through these mechanisms.

In another non-patent literature entitled, “A Synchronization Method for Timing the Network Using Single-TimeSync Frame”, the synchronization method is able to reduce network overload caused by too many messages and the processing complexity of the network devices. The synchronization method also has the advantage that does not affect the time accuracy but provides a simple process in each network device.

While the prior arts cover various solutions for the timing and synchronization (sync) requirements, however, they fail to assure that timing and sync requirements for the end to end (E2E) service configuration would be satisfied, thereby leading towards more network power consumption. The prior arts focus upon reducing network power consumption, however, they are dependent upon the condition of a base station during operation between a terminal and the base station. Further, in the prior arts, a central unit determines, based on power-saving policies, an idle period, and sends, to a distributed unit and the distributed unit activates, for the idle period, a power saving mode. The terminal does not perform inter-frequency/inter-RAT measurement when the signal quality of a serving cell (i.e., Reference Signal Received Power (RSRP) or Reference Signal Received Quality (RSPQ)) exceeds a certain threshold value for the power saving. Furthermore, the prior arts are based on a Global Positioning System (GPS)-based satellite, white rabbit synchronization technology, synchronization through timestamps etc. and include controller-based timing and synchronization and use topological network view in deciding timing flow. Such disclosed methodologies are not suitable in assuring timing and synchronization (sync) requirements while reducing network power consumption simultaneously, thereby not suitable for time-sensitive and latency-sensitive services. In light of the above-stated discussion, there is a need to overcome the above stated disadvantages.

### Object of the Disclosure

A principal object of the present disclosure is to provide a method and a network device for configuring an end-to-end data path in a transport communication network.

Another object of the present disclosure is to provide a service based topological network view in order to deploy time sensitive service for an end-to-end (E2E) service-based implementation.

Another object of the present disclosure is to realize an E2E service-based implementation of timing and synchronization architecture using an IEEE 1588 PTP protocol so that an E2E guaranteed timing and synchronization performance from a data path is achieved on which time-sensitive service is scheduled.

Another object of the present disclosure is to compute and monitor synchronization and timing QoS (quality of service) values of each network node participating in a prospective data path and decide whether that path is feasible to deploy a time sensitive service. This ensures that a data path used for time sensitive service is capable of a satisfying end to end timing and synchronization budget requirements. The proposed method supports a Programmable Service-Based Synchronization (pSBS) application which would be hosted on any SDN (software-defined network) controller. The pSBS application provides a synchronization related topological view of the deployed network cluster focusing on a synchronization hierarchy and keeps a record of all the time and synchronization QoS parameters like TE, phase delay, jitter, frequency offset observed on each node, in a centralized controller.

Another object of the present disclosure is to provide an uninterrupted end to end data transmission in a latency sensitive service.

Another object of the present disclosure is to estimate an end to end (E2E) synchronization QoS values in an effective manner.

Another object of the present disclosure is to monitor and ensure that each node in the prospective data path of a particular service has achieved the necessary E2E synchronization QoS requirements.

Another object of the present disclosure is to assist in maintaining coherent timing and synchronization requirements on each node, that is part of data transmission path chosen for transmission of time sensitive services.

### SUMMARY

Accordingly, the present disclosure provides a method for configuring an end to end data path in a transport network (wireline or wireless). The method includes computing, by a network device, at least one feasible data path between network nodes, where the network nodes are a part of different clock chains and relative to different grandmaster clocks for at least one time and latency-sensitive service. The at least one feasible data path is associated with a time synchronization protocol. Further, the method includes computing, by the network device, an E2E synchronization matrix for each of the at least one feasible data path based on a time and synchronization QoS parameter. The time and synchronization QoS parameter comprises at least one time error, a phase delay, a jitter, and a frequency offset observed on each network node in a centralized controller. The at least one feasible data path is configured for the network device hosted on a software-defined network (SDN) controller. The network device is provided with a pSBS application providing a synchronization related topological view of a deployed wireless network by focusing on a synchronization hierarchy and keeping a record of all time and synchronization QoS parameters. The E2E synchronization matrix is an E2E synchronization level topological view for at least one time and latency-sensitive service.

The network device selects the at least one feasible data path from possible data paths provided by the pSBS application for at least one time and latency-sensitive service and configures a timing profile on the network nodes. The network device manipulates synchronization in the wireless network and ensures designated synchronization QoS parameters such that a timing budget is maintained on the network nodes. The at least one feasible data path is a part of chosen data path as long as at least one time and latency-sensitive service is running.

The method further comprises facilitating, by the network device, a user interface for network administrators to monitor, configure, and alter the time and synchronization QoS parameter of the at least one network node to ensure uninterrupted end to end (E2E) synchronization-in data transmission of the at least one time and latency-sensitive service.

A Time Error (TE) budgeting at the at least one network node is computed based on:

$$\text{?}$$

$$\text{?} \text{indicates text missing or illegible when filed}$$

wherein, a type of at least one network node involved in determining the maximum TE observed on a prospective data path for the at least one time-sensitive service comprises at least one of a Service Source Node (SSN), a Service Transition Start Node (STSN), a Service Transition End Node (STEN), and a Service Termination Node (STN).

The time and latency-sensitive services include a network slicing service, a connected cars service, a self-driving car service, a tele-surgery service, a traffic efficiency and safety service, and high-frequency trading service.

The E2E synchronization matrix for each of the at least one feasible data path is computed based on a deterministic network (DetNet) model, wherein the DetNet model provides a capability to carry a specified unicast or a multicast data flowing for real-time applications with extremely low data loss rates and bounded latency.

A time synchronization comprises at least one grandmaster clock using the at least one network node associated with different clock chains for the deployment of the at least one time and latency-sensitive service.

The network device classifies that the at least one pSBS application is interacting with the at least one network device and provide a synchronization related topological view of the deployed wireless network. The network device selects the at least one feasible data path from the possible data paths provided by the pSBS application for the at least one time and latency-sensitive service.

Further, the method includes receiving, by the network device, a services indication message, wherein the services indication message indicates synchronization level topological view for at least one planned time and latency-sensitive service. Further, the method includes receiving, by a centralized controller, a pSBS application running at the SDN controller, wherein the SDN controller monitors and records a synchronization QoS parameter for the configured service synchronization flows, estimates an end to end service synchronization QoS parameters and informs the network device about the feasible synchronization path for the E2E service configuration and to meet user application's E2E synchronization service level agreement.

The network device can be a Programmable Service Based Synchronization (pSBS) controller. The time synchronization protocol may be a Precision Time Protocol (PTP), which is defined in the IEEE 1588-2008 standard.

Accordingly, the present disclosure provides a network device for configuring an end to end data path in a transport network. The network device includes a data path configuration controller coupled with a memory and a processor. The data path configuration controller computes at least one feasible data path between network nodes, where the network nodes are a part of different clock chains and relative to different grandmaster clocks for at least one time and latency-sensitive service. The at least one feasible data path is associated with a time synchronization protocol. The data path configuration controller computes an E2E synchronization matrix for each of the at least one feasible data path based on a time and synchronization QoS parameter. The time and synchronization QoS parameter comprise at least one time error, a phase delay, a jitter, and a frequency offset observed on each network node in a centralized controller. The at least one feasible data path is configured for the network device hosted on an SDN controller. The network device is provided with a pSBS application providing a synchronization related topological view of a deployed wireless network by focusing on a synchronization hierarchy and keeping a record of all time and synchronization QoS parameters. The E2E synchronization matrix is an E2E synchronization level topological view for at least one time and latency-sensitive service.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which reference letters indicate corresponding parts in the drawings. The invention herein will be better understood from the following description with reference to the drawings, in which:

FIG. 1 illustrates a conventional node-based architecture for timing and synchronization purpose.

FIG. 2 illustrates an overview of a wireless network representing pSBS-E2E service-based timing and synchronization estimation.

FIG. 3 is an example illustration in which programmable service-based synchronization (pSBS) is depicted.

FIG. 4 is an example illustration in which an SSN, an STSN, an STEN, and an STN for calculating time error (TE) in the wireless network, consisting of 3 GMS and hence 3 clock chains and a time sensitive service A, is deployed on nodes which are part of different clock chains.

FIG. 5 is a block diagram of a network device.

FIG. 6 is a flow diagram illustrating a method for configuring an end-to-end data path in the transport network.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

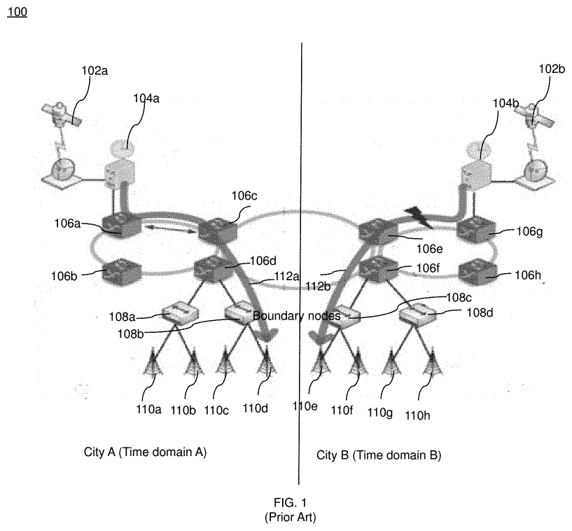

As mentioned earlier (in the background section), the node-based architecture of timing and synchronization shown in FIG. 1 is a bottleneck when it comes to deploying a critical time sensitive service with stringent E2E synchronization QoS values and E2E strict timing and synchronization budget requirements. The conventional timing and synchronization architecture do not allow to monitor and ensure that each node in a prospective data path of a particular service has achieved the necessary E2E synchronization QoS requirements.

Accordingly, the present disclosure proposes a solution discussed below.

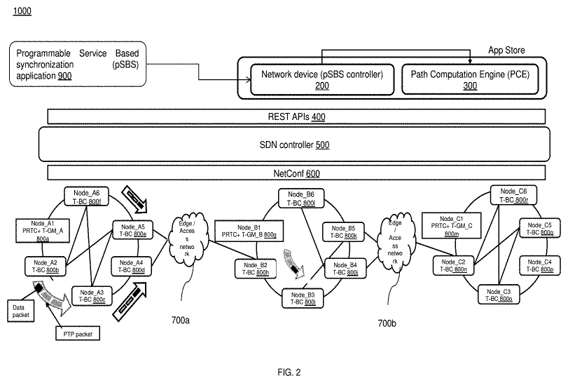

FIG. 2 illustrates an overview of a transport network (1000) in which a pSBS-E2E service-based timing and synchronization estimation is depicted. The transport network (1000) may be, for example, but not limited to a 4th generation (4G) network, a 5^{th} generation (5G) network, a virtualized Radio Access Network (RAN), and an open RAN (O-RAN). The transport network (1000) may use an IEEE 1588 Precision Time Protocol (PTP). The PTP is a packet-based two-way communications protocol specifically designed to precisely synchronize distributed clocks to sub-microsecond resolution, typically on an Ethernet or IP-based network. The IEEE 1588 can provide real-time applications with precise time-of-day (ToD) information and time-stamped inputs, as well as scheduled and/or synchronized outputs for a variety of systems, ranging from mobile networks, industrial process control, audio-visual networks, smart energy distribution to transportation, automotive and Industrial IoT networking. The transport network (1000) may also use a Network Time Protocol (NTP), where the NTP is defined by an IETF in an RFC 5905.

The transport network (1000) may include a network device (200), a path computation engine (PCE) (300), REST APIs (Representational state transfer application programming interfaces) (400), an SDN (software-defined network) controller (500), a NetConf (Network Configuration Protocol) (600), one or more edge/access network (700a and 700b), one or more network nodes (800a-800r) and a pSBS application (900). The network device (200) may also be referred to as a pSBS controller (200). The pSBS application (900) and the pSBS controller (200) may be hosted in the SDN controller (500).

The SDN controller (500) may be provided with the NetConf (600), the one or more network nodes (800a-800r) and the rest APIs (400). A NetConf, in general, is a network management protocol defined by the Internet Engineering Task Force to manage, install, manipulate, and delete the configuration of network devices. The NetConf operations are realized on top of a Remote Procedure Call (RPC) layer using an XML (Extensible Markup Language) encoding and provide a basic set of operations to edit and query configuration on a network device. The NetConf runs primarily over Secure Shell (SSH) transport. The protocol messages are exchanged on top of a secure transport protocol. In terms of SDN (Software Defined Networks), the NetConf (600) is usually a southbound API (Application Programming Interface) from the SDN controller (500) to network agents like switches and routers due to its potential for supporting multi-vendor environments.

The one or more network nodes (800a-800r) may be, for example, but not limited to a Node_A1 PRTC+T-GM_A (800a), a Node_A2 T-BC (800b), a Node_A3 T-BC (800c), a Node_A4 T-BC (800d), a Node_A5 T-BC (800e), a Node_A6 T-BC 800f (800f), a Node_B1 PRTC+T-GM_B (800g), a Node_B2 T-BC (800h), a Node_B3 T-BC (800i), a Node_B4 T-BC (800j), a Node_B5 T-BC (800k), a Node_B6 T-BC (8001), a Node_C1 PRTC+T-GM_C (800m), a Node_C2 T-BC (800n), a Node_C3 T-BC (800o), a Node_C4 T-BC (800p), a Node_C5 T-BC (800q) and a Node_C6 T-BC (800r).

The pSBS controller (200) may communicate with the PCE (application) (300) to fetch one or more data path options available for a deploying service. The pSBS controller (200) may also fetch other details from the PCE (300), like timing and synchronization budget requirements, desired synchronization QoS values and latency required for that service configuration, for example. For all the different prospective data paths available for deploying service, the pSBS controller (200) may estimate end-to-end (E2E) synchronization QoS values based on deterministic or sample topological network models and extrapolating current as well as historical data sets of an existing network.

Typically, in the deterministic network (DetNet) model, in order to meet the requirements of real-time control or automation, the transport network (1000) is designed as a time-aware network. The clock of all devices in a time-sensitive network must be synchronized. This technique can be realized through various variants of existing timing-specific protocols like IEEE 1588. One IEEE official offered synchronization standard is IEEE 802.1AS. Through network-wide shared time reference, the TSN is capable to fix the transition delays and send packets at the time arranged. The DetNet model provides a capability to carry specified unicast or multicast data flows for real-time applications with extremely low data loss rates and bounded latency within a network domain. The DetNet model is a service that can be offered by the transport network (1000) to DetNet flows. The DetNet model provides these flows with extremely low packet loss rates and assured maximum end-to-end delivery latency. This is accomplished by dedicating network resources such as link bandwidth and buffer space to DetNet flows and/or classes of DetNet flows, and by replicating packets along multiple paths. The unused reserved resources are available to non-DetNet packets.

Further, the pSBS controller (200) may finalize prospective candidate data paths based on estimated QoS values, timing budget and also take into account which data path will require minimum configuration changes in order to run a particular time sensitive service. The data computed by the pSBS controller (200) for different candidate data paths may be conveyed to the PCE (300), which helps the PCE (300) to decide the actual data path that is suitable for deploying time sensitive service.

Based on the chosen data path by the PCE (300), the pSBS controller (200) may take action of configuring appropriate timing profile on the nodes (800a-800r) and manipulate synchronization tree in the transport network (1000) to ensure that the designated synchronization QoS parameters and timing budget are maintained on each node, which is part of chosen data path as long as time sensitive service is running. Further, the pSBS controller (200) may calculate and monitor the synchronization and timing QoS values of each network node (800a-800r) participating in the prospective data path and decide whether that path is feasible to deploy the time sensitive service or not. This ensures that the data path used for the time sensitive service is a satisfying end to end timing and synchronization budget requirements to run that service.

The pSBS controller (200) may provide the E2E synchronization level topological view for running/planned service (i.e., service-based synchronization flows) (explained below). The pSBS controller (200) may monitor, record synchronization QoS parameter for the configured service synchronization flows. The pSBS controller (200) may estimate the end-to-end service synchronization QoS parameters and inform the PCE (300) about the feasible synchronization path for E2E service configuration.

The PCE (300) is a system component, application, or network node that may be capable of determining and finding a suitable route for conveying data between a source node and a destination node. The PCE (300) is a device that may compute paths on behalf of the nodes (800a-800r) in the transport network (1000). The PCE (300) may be a router, a Commercial off-the-shelf (COTS) server, part of operations supports systems (OSS), or a virtualized entity running in a cloud/server. When the network nodes (800a-800r) need a path for an LSP (link state packet), it makes a request to the PCE (300) using the PCE protocol (PCEP). The PCE (300) has access to topology information for the entire transport network (1000) and uses this in path computations.

The PCE (300) may provide open software APIs such as the REST APIs (400), to allow the operators to customize or replace routing algorithms. These interfaces allow the OSS to influence network behavior via the PCE (300), in place of direct communications with every network element (NE) in the transport network (1000). Advantageously, this is a much more reliable way to manage the wireless network (or network) (1000) and is cheaper for the OSS vendors to develop and for the OSS users to run. The increased flexibility and openness for customization enable operators to address the rapid change of pace set by applications and traffic flows.

The pSBS application (900) may provide a user interface so that a network administrator can also monitor, configure, and alter timing and synchronization parameters (e.g., TE, phase delay, jitter or the like) of each node in the transport network (1000) to ensure uninterrupted end to end data transmission of latency sensitive services. The pSBS application (900) may act as a plugin, having synchronization related topological view and may be hosted on the SDN controller (500). The pSBS application (900) may assist the PCE (300) to decide optimum route/path for the running/planned service, where the services include, any time-sensitive service (e.g., forex service, a network slicing service, connected cars service, self-driving car service, tele-surgery service, traffic efficiency & safety service, high-frequency trading service, etc.).

The pSBS application (900) may provide a synchronization related topological view of the deployed network cluster focusing on the synchronization hierarchy. It keeps a record of all the time and synchronization QoS parameters like TE, phase delay, jitter, frequency offset observed on each node, in a centralized controller (not shown). The centralized controller may receive the pSBS application (900) running at the SDN controller (500), wherein the SDN controller (500) monitors and records a synchronization QoS parameter for configured service synchronization flows, estimates end-to-end service synchronization QoS parameters and informs the network device (200) about a feasible synchronization path for the E2E service configuration and to meet user application's E2E synchronization service level agreement.

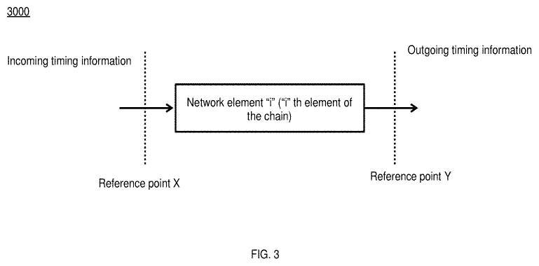

FIG. 3 is an example illustration (3000) in which programmable service-based synchronization is depicted. The programmable service-based synchronization may be done by accumulating time errors in a chain of clocks. As per ITU-TG.8271.1/Y.1366.1 standards, the following approach may be used to illustrate the accumulation of time error in the chain of clocks.

As shown in FIG. 3, the maximum absolute TE at point Y depends on a constant TE at X(cTE_{X}), where the constant TE is introduced by network element I(cTEᵢ), a low-band dynamic TE at X (i.e., inherent low-pass nature of the clock filtering in a network element filters out high-band dynamic TE at X) (dTE_{L}, x(t)), and the dynamic TE introduced by network element i (low-band and high-band). The maximum absolute TE is (dTE_{L,i}(t))+dTE_{H,i}(t)|).

Based on maximum absolute TE, the total accumulated TE at point Y is:

max|TE_{Y}|=max|(cTE_{X}+cTEᵢ)+(dTE_{L,X}(t)+dTE_{L,i}(t))+dTE_{H,i}(t)| Equation (1)

By applying a first order approximation in the chain of time clocks, the constant TE, and link asymmetry accumulates linearly, the low-band dynamic TE accumulates incoherently, and the high-band dynamic TE is contributed mainly by the last element in the chain. In the chain of time clocks, where N nodes are indexed by the letter i, and (N−1) links are indexed by the letter j, (considering linkTEj denotes the asymmetry of link j), the maximum absolute TE at the output of the Nth node can be upper bounded as:

$$\text{?} \qquad Equation ( 2 )$$

$$\text{?} \text{indicates text missing or illegible when filed}$$

By using this equation (2), the user of the transport network (1000) can properly estimate the accumulated TE at end node (800r) only if the user of the transport network (1000) is deploying service on nodes (800a-800r), which are sourcing timing data from the same GM (grandmaster).

There are different factors that affect TE on the network node (800a-800r) such as clock class of GM clock, hop distance of the network node (800a-800r) from the GM, and quality of oscillator used in a network node (800a-800r).

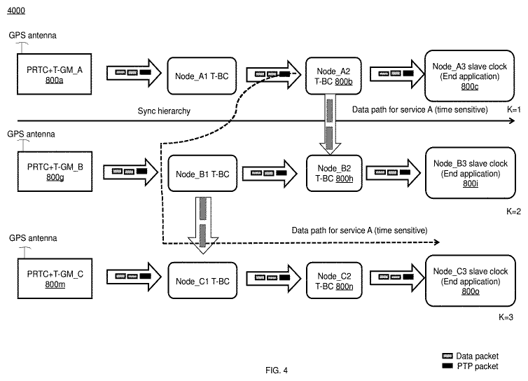

In order to estimate the time error (TE) on each node (800a-800r), the proposed method uses following approach as discussed in the FIG. 4. The method takes into account all the nodes (800a-800r) involved in the data path of service which may have different GMs, the user of the transport network (1000) plans to enhance the equation (2) by considering not only the absolute value of cTE and dTE of the node (800a-800r) (given in data sheet/specified by manufacturer) but the actual accumulated cTE and dTE in some cases.

FIG. 4 is an example illustration (4000) in which a Service Source Node (SSN), a Service Transition Start Node (STSN), a Service Transition End Node (STEN), and a Service Termination Node (STN) for calculating the TE in the transport network (1000), consisting 3 GMS (k=3) and hence 3 clock chains and a time sensitive service A, is deployed on the network nodes (800a-880r) which are part of different clock chains.

As shown in FIG. 4, there are 3 GMs and hence 3 chains involved in the data path of time sensitive service A (k=3). Consider, Node_A2 as an initial node, so the proposed solution will consider it as the Service Source Node (SSN) and the Node_B2 as a starting node on which service transits into, so the proposed solution will consider it as the Service Transition Start Node (STSN). The Node_B1 is a very last node from which service makes transition from, so it will be considered as the Service Transition End Node (STEN). Similarly, Node_C1 will be considered as the STSN, Node_C3 as the STN, and rest all nodes in each chain do not need separate attention as their TE have been already taken care of in the accumulated TE formula.

The proposed solution may identify four different categories of network nodes (800a-800r), which play important role in determining maximum TE observed on the prospective data path of time sensitive service.

Step 1—SSN: This is the source/initial node on the data path of time sensitive service. The method may consider the accumulated TE of the SSN (from GM through other nodes till SSN). This is because although the other nodes prior to the SSN are not the part of the service data path, the method cannot simply ignore their contribution towards TE experienced by the SSN and hence by the service. Thus,

max|TE_{service(step1)}|=max|TE_{SSN(accumulated)}|

Where,

$$max \vert {TE}_{SSN ( accumulated )} \vert \leq {\sum }_{i = 1}^{{N}_{SSN}} \vert {cTE}_{i} \vert + {\sum }_{j = 2}^{{N}_{SSN} - 1} \vert {linkTE}_{j} + \sqrt{\{ {\sum }_{i = 2}^{{N}_{SSN}} {[ max \vert {dTE}_{L , i} ( t ) \vert ]}^{2} \} + {[ max \vert {dTE}_{H , {N}_{SSN}} ( t ) \vert ]}^{2}}$$

Where N_{SSN}—the hop distance of SSN from its GM, and i represents a number of nodes in that chain from GM to SSN.

Step 2—STSN: Whenever, transition of service data-path between clock chain of two different GMs is involved, the very first node at which the service makes the transition into, is termed as the STSN. This node comes into play when there is a transition in the data path of the service from ‘particular chain sourced by particular GM’ to ‘next different chain which is sourced by different GM’. The proposed solution will compare (max|TE_{Service(prior to STSN)}|) with max accumulated TE at the STSN in its own clock chain i.e., (max|TE_{STSN(accumulated)}|).

max|TE_{service(step2)}|=maximum of {max|TE_{service(prior to STSN)}|, max|TE_{STSN(accumulated)}|}

where

$$max \vert {TE}_{STSN ( accumulated )} \vert \leq {\sum }_{i = 1}^{{N}_{STSN}} \vert {cTE}_{i} \vert + {\sum }_{j = 2}^{{N}_{STSN} - 1} \vert {linkTE}_{j} \vert + \sqrt{\{ {\sum }_{i = 2}^{{N}_{STSN}} {[ max \vert {dTE}_{L , i} ( t ) \vert ]}^{2} \} + {[ max \vert {dTE}_{H , {N}_{STSN}} ( t ) \vert ]}^{2}}$$

Where, N_{STSN}—the hop distance of STSN from its GM and i represents number of nodes in that chain from GM to STSN.

As there may be multiple transitions of service in the data path, multiple number of chains may be encountered and hence multiple number of STSN. Thus step 2 is recurring step in the proposed solution.

Step 3—STEN: Whenever, there involves transition of service data-path between clock chain of two different GMs, the very last node from which service makes transition from is termed as the STEN. The STEN comes into play, when there is a transition in data path of service from ‘particular chain sourced by particular GM’ to ‘next different chain which is sourced by different GM’. The proposed solution will compare (max|TE_{Service((prior to STEN)}|) calculated in earlier steps, to the max accumulated TE at STEN in its own clock chain i.e. (max|TE_{STEN(accumulated)}|).

max|TE_{service(step3)}|=maximum of {max|TE_{service((prior to STEN)}|, max|TE_{STEN(accumulated)}|}

where

$$max \vert {TE}_{STEN ( accumulated )} \vert \leq {\sum }_{i = 1}^{{N}_{STEN}} \vert {cTE}_{i} \vert + {\sum }_{j = 2}^{{N}_{STEN} - 1} \vert {linkTE}_{j} \vert + \sqrt{\{ {\sum }_{i = 2}^{{N}_{STEN}} {[ max \vert {dTE}_{L , i} ( t ) \vert ]}^{2} \} + {[ max \vert {dTE}_{H , {N}_{STEN}} ( t ) \vert ]}^{2}}$$

Where N_{STEN}—the hop distance of STEN from its GM and i represents number of nodes in that chain from GM to STEN.

As there may be multiple transitions of service in data path, multiple number of chains may be encountered and hence multiple number of STEN. Thus, step 3 is recurring step in the proposed solution.

Step 4—STN: This is the end node on data path of time sensitive service at which service will terminate. Herein, accumulated TE of the STN (from GM through other nodes till STN) is also considered. This is because although the other nodes prior to STN may or may not be part of service data path, so the proposed solution cannot simply ignore their contribution towards TE experienced by the STN and hence by the service. The proposed solution will compare (max|TE_{Service(step3)}|)=max|TE_{STSN(accumulated)}|) calculated in step 3 with max accumulated TE at the STN in its own clock chain i.e. (max|TE_{STN(accumulated)}|). Thus,

max|TE_{service(step4)}|=maximum of {max|TE_{servcie(prior to STN)}|, max|TE_{STN(accumulated)}|}

where

$$max \vert {TE}_{STN ( accumulated )} \vert \leq {\sum }_{i = 1}^{{N}_{STN}} \vert {cTE}_{i} \vert + {\sum }_{j = 2}^{{N}_{STN} - 1} \vert {linkTE}_{j} \vert + \sqrt{\{ {\sum }_{i = 2}^{{N}_{STN}} {[ max \vert {dTE}_{L , i} ( t ) \vert ]}^{2} \} + {[ max \vert {dTE}_{H , {N}_{STN}} ( t ) \vert ]}^{2}}$$

Where N_{STN}—the hop distance of STN from its GM and i represents number of nodes in that chain from GM to SSN.

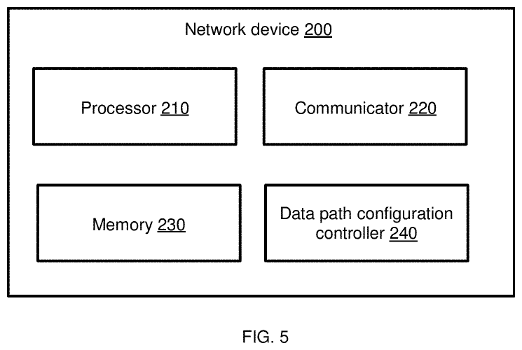

FIG. 5 is a block diagram representing various hardware elements of the network device (200). The network device (200) may include a processor (210), a communicator (220), a memory (230), and a data path configuration controller (240).

The data path configuration controller (240) may compute at least one data path (feasible data path) between network nodes (800a-800r). The network nodes (800a-800r) are the part of different clock chains and relative to different grandmaster clocks for at least one time and latency-sensitive service. The at least one data path is associated with a time synchronization protocol (i.e., PTP defined in the IEEE 1588-2008 standard). Further, the data path configuration controller (240) may compute an E2E synchronization matrix for each of the at least one feasible data path based on a time and synchronization QoS parameter. The at least one feasible data path may be configured for the network device (200) hosted on the SDN controller (500). The network device (200) may be provided with the pSBS application (900) providing the synchronization related topological view of the deployed transport network (1000) by focusing on a synchronization hierarchy and keeping a record of all time and synchronization QoS parameters. The E2E synchronization matrix is an E2E synchronization level topological view for the at least one time and latency-sensitive service. The E2E synchronization matrix for each of the at least one feasible data path may be computed based on the DetNet model as discussed above. The DetNet model provides the capability to carry a specified unicast or multicast data flowing for real-time applications with extremely low data loss rates and bounded latency.

Further, the data path configuration controller (240) may select the feasible data paths from possible data paths provided by the pSBS application (900) for the time and latency-sensitive service and configure the timing profile on the network nodes (800a-800r). The data path configuration controller (240) may manipulate synchronization in the transport network (1000) and ensure designated synchronization QoS parameters such that a timing budget is maintained on the network nodes (800a-800r). The feasible data paths are a part of chosen data path as long as at least one time and latency-sensitive service is running.

The data path configuration controller (240) may facilitate a user interface for network administrators to monitor, configure, and alter the time and synchronization QoS parameter of at least one network node (800a-800r) to ensure uninterrupted end to end (E2E) synchronization-in data transmission of the at least one time and latency-sensitive service.

Further, the data path configuration controller (240) may classify that at least one pSBS application (900) is interacting with at least one network device (200) and provide a synchronization related topological view of the deployed transport network (1000). The data path configuration controller (240) may select the at least one feasible data path from the possible data paths provided by the at least one pSBS application (900) for the at least one time and latency-sensitive service. The data path configuration controller (240) may receive a services indication message, wherein the services indication message indicates synchronization level topological view for at least one planned time and latency-sensitive service.

The processor (210) may be configured to execute instructions stored in the memory (230) and to perform various processes as discussed above. The communicator (220) may be configured for communicating internally between internal hardware components and with external devices via one or more networks.

The memory (230) may store instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In some examples, the memory (230) may be configured to store large amount of information. In certain examples, a non-transitory storage medium may store data that can, over time, change (e.g., in Random Access Memory (RAM) or cache).

Although, FIG. 5 shows various hardware components of the network device (200) but it is to be understood that other implementations are not limited thereon. The network device (200) may include less or more number of components. Further, the labels or names of the components are used only for illustrative purpose and does not limit the scope of the present disclosure. One or more components may be combined together to perform the same or substantially similar function in the network device (200).

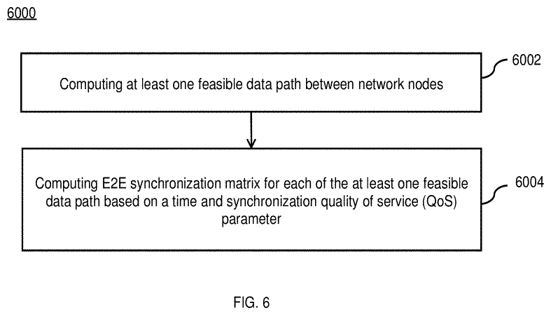

FIG. 6 is a flow diagram (6000) illustrating a method for configuring the end-to-end data path in the transport network (1000). It may be noted that in order to explain the method steps of the flowchart (6000), references will be made to the elements explained in FIG. 2 to FIG. 5. The operations (6002 and 6004) are performed by the data path configuration controller (240).

At 6002, the method includes computing at least one feasible data path between the network nodes (800a-800r). The network nodes (800a-800r) are the part of different clock chains and relative to different grandmaster clocks for at least one time and latency-sensitive service. The at least one feasible data path is associated with the time synchronization protocol. At S6004, the method includes computing the E2E synchronization matrix for each of the feasible data paths based on the time and synchronization QoS parameter.

It may also be noted that the flowchart (6000) is explained to have above stated process steps; however, those skilled in the art would appreciate that the flowchart (6000) may have more/less number of process steps which may enable all the above stated implementations of the present disclosure.

The various actions acts, blocks, steps, or the like in the flow chart may be performed in the order presented, in a different order or simultaneously. Further, in some implementations, some of the actions, acts, blocks, steps, or the like may be omitted, added, modified, skipped, or the like without departing from the scope of the invention.

Unlike conventional methods and systems, the proposed solution provides the service based topological network view in order to deploy time sensitive service for the end-to-end service-based implementation. The proposed solution can be used to realize the E2E service-based implementation of timing and synchronization architecture using the IEEE 1588 PTP protocol, so that a E2E guaranteed timing and synchronization performance from a data path is achieved on which time-sensitive service is scheduled. The proposed solution can be used to assist in maintaining coherent timing and synchronization requirements on each node, that is part of data transmission path chosen for transmission of time sensitive service.

Further, the proposed solution can be used to compute and monitor synchronization and timing QoS values of each network node participating in the prospective data path and decide whether that path is feasible to deploy a time sensitive service or not. This ensures that a data path used for time sensitive service is a satisfying end to end timing and synchronization budget requirements. The proposed solution can be used to provide an uninterrupted end to end data transmission of latency sensitive services and to estimate the E2E (end to end) synchronization QoS values in an effective manner.

Advantageously, the proposed solution can be implemented in handovers (RU-RU), network slicing scenario, a real time RIC controller for intra and inter cluster services, edge network requirements for deploying connected vehicles service, a tele-surgery scenario, traffic efficiency and safety scenario, and a high-frequency trading scenario, for example. Also, the proposed solution can be implemented in latency sensitive 5G and next-generation broadband applications. The proposed solution can also be used to monitor and ensure that each node (800a-800r) in the prospective data path of the particular service has achieved the necessary E2E synchronization QoS requirements.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repositories, such as relational databases and flat file systems that use volatile and/or non-volatile memory (e.g., magnetic disk storage, optical storage, EEPROM and/or solid-state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey those certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. A method for configuring an end-to-end data path in a transport network (1000), the method comprising:
computing, by a network device (200), at least one feasible data path between network nodes (800a-800r), where the network nodes (800a-800r) are a part of different clock chains and relative to different grandmaster clocks for at least one time and latency-sensitive service, wherein the at least one feasible data path is associated with a time synchronization protocol; and
computing, by the network device (200), an end-to-end (E2E) synchronization matrix for each of the at least one feasible data path based on a time and synchronization quality of service (QoS) parameter, wherein the time and synchronization QoS parameter comprises at least one of a time error, a phase delay, a jitter, and a frequency offset observed on each network node (800a-800r) in a centralized controller;
wherein the at least one feasible data path is configured for the network device (200) hosted on a software-defined network (SDN) controller (500), wherein the network device (200) is provided with a pSBS (programmable service-based synchronization) application (900) providing a synchronization related topological view of a deployed transport network (1000) by focusing on a synchronization hierarchy and keeping a record of all time and synchronization QoS parameters; and
wherein the E2E synchronization matrix is an E2E synchronization level topological view for the at least one time and latency-sensitive service.

2. The method as claimed in claim 1, wherein the network device (200) selects the at least one feasible data path from possible data paths provided by the pSBS application (900) for at least one time and latency-sensitive service and configures a timing profile on the network nodes (800a-800r), wherein the network device (200) manipulates synchronization in the transport network (1000) and ensure a designated synchronization QoS parameters such that a timing budget is maintained on the network nodes (800a-800r), wherein the at least one feasible data path is a part of chosen data path as long as the at least one time and latency-sensitive service is running.

3. The method as claimed in claim 1 further comprising: facilitating, by the network device (200), a user interface for network administrators to monitor, configure, and alter the time and synchronization QoS parameter of the at least one network node (800a-800r) to ensure uninterrupted end to end (E2E) synchronization-in data transmission of the at least one time and latency-sensitive service.

4. The method as claimed in claim 1, wherein a Time Error (TE) budgeting at the at least one network node (800a-800r) is computed based on
$$\text{?}$$
$$\text{?} \text{indicates text missing or illegible when filed}$$
wherein, a type of the at least one network node (800a-800r) involved in determining a maximum TE observed on a prospective data path for the at least one time-sensitive service comprises at least one of a Service Source Node (SSN), a Service Transition Start Node (STSN), a Service Transition End Node (STEN), and a Service Termination Node (STN).

5. The method as claimed in claim 1, wherein the time and latency-sensitive service comprises a network slicing service, a connected cars service, a self-driving car service, a tele-surgery service, traffic efficiency and safety service, and high-frequency trading service.

6. The method as claimed in claim 1, wherein the E2E synchronization matrix for each of the at least one feasible data path is computed based on a deterministic network (DetNet) model, wherein the DetNet model provides a capability to carry a specified unicast or a multicast data flowing for real-time applications with extremely low data loss rates and bounded latency.

7. The method as claimed in claim 1, wherein a time synchronization comprises at least one grandmaster clock using the at least one network node (800a-800r) associated with different clock chains for the deployment of the at least one time and latency-sensitive service.

8. The method as claimed in claim 1, wherein the network device (200) classifies that the pSBS application (900) is interacting with the network device (200) and provides a synchronization related topological view of the deployed transport network (1000), wherein the network device (200) selects the at least one feasible data path from the possible data paths provided by the pSBS application (900) for the at least one time and latency-sensitive service.

9. The method as claimed in claim 1, wherein the method further comprises:
receiving, by the network device (200), a services indication message, wherein the services indication message indicates synchronization level topological view for at least one planned time and latency-sensitive service, and
receiving, by the centralized controller, the pSBS application (900) running at the SDN controller (500), wherein the SDN controller (500) monitors and records a synchronization QoS parameter for configured service synchronization flows, estimates an end-to-end service synchronization QoS parameters and informs the network device (200) about a feasible synchronization path for the E2E service configuration and to meet user application's E2E synchronization service level agreement.

10. The method as claimed in claim 1, wherein the network device (200) comprises a Programmable Service Based Synchronization (pSBS) controller.

11. The method as claimed in claim 1, wherein the time synchronization protocol comprises a Precision Time Protocol (PTP), which is defined in the IEEE 1588-2008 standard.

12. A network device (200) for configuring an end-to-end data path in a transport network (1000), the network device (200) comprising:
a data path configuration controller (240) configured to:
compute at least one feasible data path between network nodes (800a-800r), where the network nodes (800a-800r) are a part of different clock chains and relative to different grandmaster clocks for at least one time and latency-sensitive service, wherein the at least one feasible data path is associated with a time synchronization protocol; and
compute an end-to-end (E2E) synchronization matrix for each of the at least one feasible data path based on a time and synchronization quality of service (QoS) parameter, wherein the time and synchronization QoS parameter comprises at least one of a time errors, a phase delay, a jitter, and a frequency offset observed on each network node (800a-800r) in a centralized controller;
wherein the at least one feasible data path is configured for the network device (200) hosted on a software-defined network (SDN) controller (500), wherein the network device (200) is provided with a pSBS (programmable service-based synchronization) application (900) providing a synchronization related topological view of a deployed transport network (1000) by focusing on a synchronization hierarchy and keeping a record of all time and synchronization QoS parameters; and
wherein the E2E synchronization matrix is an E2E synchronization level topological view for the at least one time and latency-sensitive service.

13. The network device (200) as claimed in claim 12, wherein the data path configuration controller (240) selects the at least one feasible data path from possible data paths provided by the pSBS application (900) for at least one time and latency-sensitive service and configures a timing profile on the network nodes (800a-800r), wherein the data path configuration controller (240) manipulates synchronization in the transport network (1000) and ensure a designated synchronization QoS parameters such that a timing budget is maintained on the network nodes (800a-800r), wherein the at least one feasible data path is a part of chosen data path as long as the at least one time and latency-sensitive service is running.

14. The network device (200) as claimed in claim 12, wherein the data path configuration controller (240) facilitates a user interface for network administrators to monitor, configure, and alter the time and synchronization QoS parameter of the at least one network node (800a-800r) to ensure uninterrupted end to end (E2E) synchronization-in data transmission of the at least one time and latency-sensitive service.

15. The network device (200) as claimed in claim 12, wherein a Time Error (TE) budgeting at the at least one network node (800a-800r) is computed based on
$$\text{?}$$
$$\text{?} \text{indicates text missing or illegible when filed}$$
wherein, a type of the at least one network node (800a-800r) involved in determining a maximum TE observed on a prospective data path for the at least one time-sensitive service comprises at least one of a Service Source Node (SSN), a Service Transition Start Node (STSN), a Service Transition End Node (STEN), and a Service Termination Node (STN).

16. The network device (200) as claimed in claim 12, wherein the time and latency-sensitive service comprises a network slicing service, a connected cars service, a self-driving car service, a tele-surgery service, a traffic efficiency and safety service, and a high-frequency trading service.

17. The network device (200) as claimed in claim 12, wherein the E2E synchronization matrix for each of the at least one feasible data path is computed based on a deterministic network (DetNet) model, wherein the DetNet model provides a capability to carry a specified unicast or a multicast data flowing for real-time applications with extremely low data loss rates and bounded latency.

18. The network device (200) as claimed in claim 12, wherein a time synchronization comprises at least one grandmaster clock using the at least one network node (800a-800r) associated with different clock chains for the deployment of the at least one time and latency-sensitive service.

19. The network device (200) as claimed in claim 12, wherein the data path configuration controller (240) classifies that the pSBS application (900) is interacting with the network device (200) and provides a synchronization related topological view of the deployed transport network (1000), wherein the data path configuration controller (240) selects the at least one feasible data path from the possible data paths provided by the pSBS application (900) for the at least one time and latency-sensitive service.

20. The network device (200) as claimed in claim 12, wherein the data path configuration controller (240) receives a services indication message, wherein the services indication message indicates synchronization level topological view for at least one planned time and latency-sensitive service.

21. The network device (200) as claimed in claim 12, wherein the network device (200) comprises a Programmable Service Based Synchronization (pSBS) controller.

22. The network device (200) as claimed in claim 12, wherein the time synchronization protocol comprises a Precision Time Protocol (PTP), which is defined in the IEEE 1588-2008 standard.
